(19) United States
(12) Patent Application Publication
(10) Pub. No.: US 2020/0090240 A1
(43) Pub. Date: Mar. 19, 2020

(54) Machine Learning Technique in Real-Time Quoting System to Optimize Quote Conversion Rates

(71) Applicant: Dell Products L.P., Round Rock, TX (US)

(72) Inventors: Moloy K. Sinha, Asansol (IN); Madhav Parashar, Agra (IN); Sunil Pawar, Bangalore (IN); Renita Oliveira, Bangalore (IN); Saurav Daga, Bangalore (IN)

(73) Assignee: Dell Products L.P., Round Rock, TX (US)

(21) Appl. No.: 16/131,819

(22) Filed: Sep. 14, 2018

(51) Int. Cl. G06Q 30/06; G06N 5/02

(52) U.S. Cl. CPC G06Q 30/0611; G06N 5/022

(57) ABSTRACT

A system, method, and computer-readable medium for optimizing quote conversion rates. The optimizing quote conversion rates includes identifying an open quote associated with a particular potential acquirer of a deliverable; identifying input data related to the open quote; generating a prediction of a propensity of a particular open quote to be converted using the input data; and, using the prediction of the propensity of the particular open quote to optimize conversion of the open quote.

### BACKGROUND OF THE INVENTION

### Field of the Invention

The present invention relates to information handling systems. More specifically, embodiments of the invention relate to optimizing quote conversion rates.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

A system, method, and computer-readable medium for optimizing quote conversion rates.

In one embodiment, the invention relates to a method for optimizing quote conversion rates, comprising: identifying an open quote associated with a particular potential acquirer of a deliverable; identifying input data related to the open quote; generating a prediction of a propensity of a particular open quote to be converted using the input data; and, using the prediction of the propensity of the particular open quote to optimize conversion of the open quote.

In another embodiment, the invention relates to a system comprising: a processor; a data bus coupled to the processor; and a non-transitory, computer-readable storage medium embodying computer program code, the non-transitory, computer-readable storage medium being coupled to the data bus, the computer program code interacting with a plurality of computer operations and comprising instructions executable by the processor and configured for: identifying an open quote associated with a particular potential acquirer of a deliverable; identifying input data related to the open quote; generating a prediction of a propensity of a particular open quote to be converted using the input data; and, using the prediction of the propensity of the particular open quote to optimize conversion of the open quote.

In another embodiment, the invention relates to a non-transitory, computer-readable storage medium embodying computer program code, the computer program code comprising computer executable instructions configured for: identifying an open quote associated with a particular potential acquirer of a deliverable; identifying input data related to the open quote; generating a prediction of a propensity of a particular open quote to be converted using the input data; and, using the prediction of the propensity of the particular open quote to optimize conversion of the open quote.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention.

FIG. 2 shows a block diagram of a quote conversion optimization environment.

FIG. 3 shows a functional block diagram of a quote conversion process.

FIG. 4 shows functional block diagram of the use of a quote prediction model in a quote conversion optimization process.

FIG. 5 shows a flow chart of the performance of quote prediction model operations.

FIG. 6 shows a functional block diagram of the operation of quote prediction model.

FIGS. 7a through 7c show a logistic model implemented as a quote prediction model.

FIG. 8 shows a simplified block diagram of variables associated with a quote prediction model.

FIG. 9 is a table of quote variables and associated input data.

FIG. 10 shows a flowchart of the performance of quote conversion propensity prediction operations.

FIG. 11 shows a functional block diagram of the operation of a quote conversion optimization system.

FIG. 12 shows an example screen presentation of a quote conversion optimization system user interface.

### DETAILED DESCRIPTION

A system, method, and computer-readable medium are disclosed for optimizing quote conversion rates. In certain embodiments, various quote conversion optimization operations may be performed to optimize the conversion of an open quote, as described in greater detail herein. In certain embodiments, the quote conversion optimization operations may include the use of various historical information associated with a quote requestor, a particular quote request, a quote provider, and previously-converted quotes. In certain embodiments, performance of the quote conversion operations may provide a prediction of the propensity of a particular open quote to be converted. Accordingly, certain aspects of the invention reflect an appreciation that identification of an open quote with a higher propensity for conversion allows a quote provider to facilitate its successful conversion rather that needlessly expending effort on an open quote with a low propensity for conversion.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

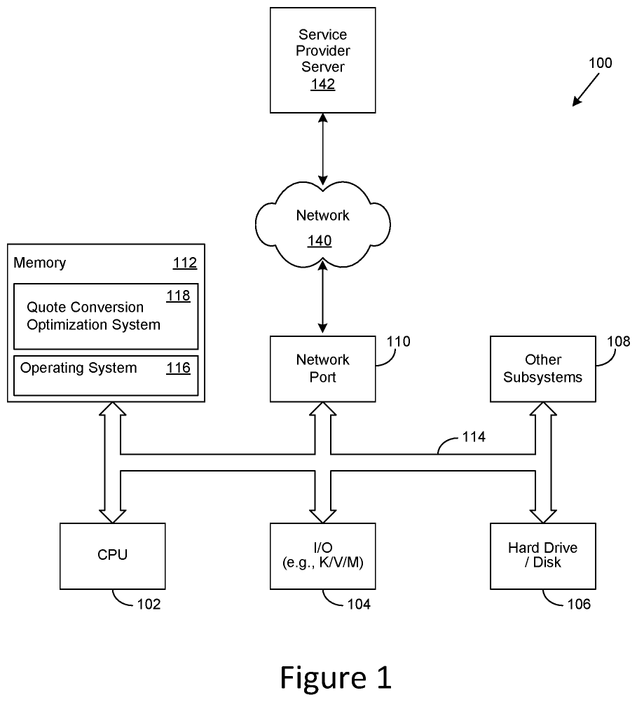

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise a quote conversion optimization system 118.

The quote conversion optimization system 118 performs a quote conversion optimization operation. The quote conversion optimization system 118 operation improves processor efficiency (and thus the efficiency of the information handling system 100) facilitating a quote conversion optimization operation. In certain embodiments, the quote conversion optimization operation can optimize the conversion of quotes during operation of an information handling system 100. As will be appreciated, once the information handling system 100 is configured to perform the quote conversion optimization operation, the information handling system 100 becomes a specialized computing device specifically configured to perform the system failure identification operation and is not a general purpose computing device. Moreover, the implementation of the quote conversion optimization operation on the information handling system 100 improves the functionality of the information handling system 100 and provides a useful and concrete result of optimizing the conversion of quotes. In certain embodiments, the quote conversion optimization operation results in optimizing the conversion of quotes.

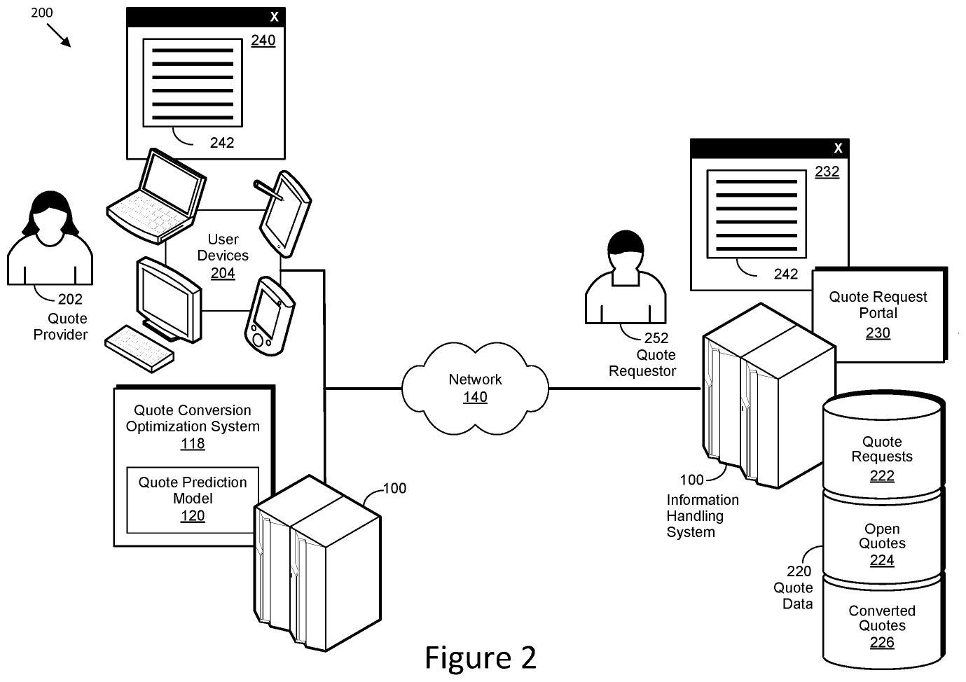

FIG. 2 shows a block diagram of a quote conversion optimization environment 200 implemented in accordance with an embodiment of the invention. In certain embodiments, the quote conversion optimization environment 200 may include a quote conversion optimization system 118. In certain embodiments, the quote conversion optimization system 118 may include a quote prediction model 120, which interacts with the quote conversion optimization system 118 when performing various quote conversion optimization operations, described in greater detail herein. In certain embodiments, the quote conversion optimization system 118 may likewise include a quote request portal 122. In certain embodiments, the quote request portal 122 may be implemented on a separate information handling system 100.

In certain embodiments, the quote conversion optimization environment 200 may include a repository of quote data 220. In certain embodiments, the repository of quote data 220 may be local to the system executing the quote conversion optimization system 118 or may be executed remotely. In certain embodiments, the repository of quote data 220 may include various information associated with quote requests 222, open quotes 224, and converted quotes 226.

In certain embodiments, the quote request portal 230 may be implemented to receive quote requests 222 from a quote requestor 252. In certain embodiments, the quote requestor 252 may be an individual, a representative of an organization, a system, an automated or semi-automated process, or a combination thereof. In various embodiments, the quote requests 222 received by the quote request portal 230 may be stored in the repository of quote data 220.

In certain embodiments, information associated with the quote requests 222 and stored in the repository of quote data 220 may be used to generate an open quote 224, described in greater detail herein. In certain embodiments, the open quote 224 may be generated by a quote provider 202. In certain embodiments, the quote provider 202 may be an individual, a representative of an organization, a system, an automated or semi-automated process, or a combination thereof. In certain embodiments, the open quote 224 may be stored in the repository of quote data 220.

In certain embodiments, the quote conversion optimization system 118 may be implemented to predict the propensity of an open quote 224 to be converted into a converted quote 226, described in greater detail herein. In various embodiments, the quote conversion optimization system 118 may be implemented to use certain historical information to predict the propensity of an open quote 224 to be converted into a converted quote 226. In certain embodiments, such historical information may be associated with the quote requestor 252, a particular quote request 222, the quote provider 202, and previously-converted quotes 226.

In certain embodiments, the quote provider 202 may use a user device 204 to interact with the quote conversion optimization system 118. As used herein, a user device 204 refers to an information handling system such as a personal computer, a laptop computer, a tablet computer, a personal digital assistant (PDA), a smart phone, a mobile telephone, or other device that is capable of communicating and processing data. In certain embodiments, the user device 204 may be configured to present a quote conversion optimization system user interface (UI) 240. In certain embodiments, the quote conversion optimization system UI 240 may be implemented to present a graphical representation 242 of quote conversion optimization information, which is automatically generated in response to interaction with the quote conversion optimization system 118. In certain embodiments, the user device 204 is used to exchange information between the quote provider 202 and the quote conversion optimization system 118, a product configuration system 250, and a custom product fabrication system 250, through the use of a network 140. In certain embodiments, the network 140 may be a public internet protocol (IP) network, such as the Internet, a physical private network, a wireless network, a virtual private network (VPN), or any combination thereof. Skilled practitioners of the art will recognize that many such embodiments are possible and the foregoing is not intended to limit the spirit, scope or intent of the invention.

In various embodiments, the quote conversion optimization system user interface (UI) 240 and the quote request portal 230 may be presented via a website. In certain embodiments, the website may be provided by one or more of the quote conversion optimization system 118. For the purposes of this disclosure a website may be defined as a collection of related web pages which are identified with a common domain name and is published on at least one web server.

A website may be accessible via a public internet protocol (IP) network or a private local network. A web page is a document which is accessible via a browser which displays the web page via a display device of an information handling system. In various embodiments, the web page also includes the file which causes the document to be presented via the browser. In various embodiments, the web page may comprise a static web page which is delivered exactly as stored and a dynamic web page which is generated by a web application that is driven by software that enhances the web page via user input to a web server.

In certain embodiments, the quote conversion optimization system 118 may be implemented to interact with the product configuration system 250, which in turn may be executing on a separate information handling system 100. In various embodiments, the product configuration system 250 interacts with the custom product fabrication system 252. In various embodiments, the custom product fabrication system 252 fabricates products corresponding to one or more deliverables, described in greater detail herein, associated with a particular converted quote. In certain embodiments, the propensity of a quote to be converted may be improved by certain functionalities provided by the quote conversion optimization system 118. In various embodiments, the quote conversion optimization system UI 240 may be presented via a website. In various embodiments, the website is provided by one or more of the quote conversion optimization system 118 and the product configuration system 250.

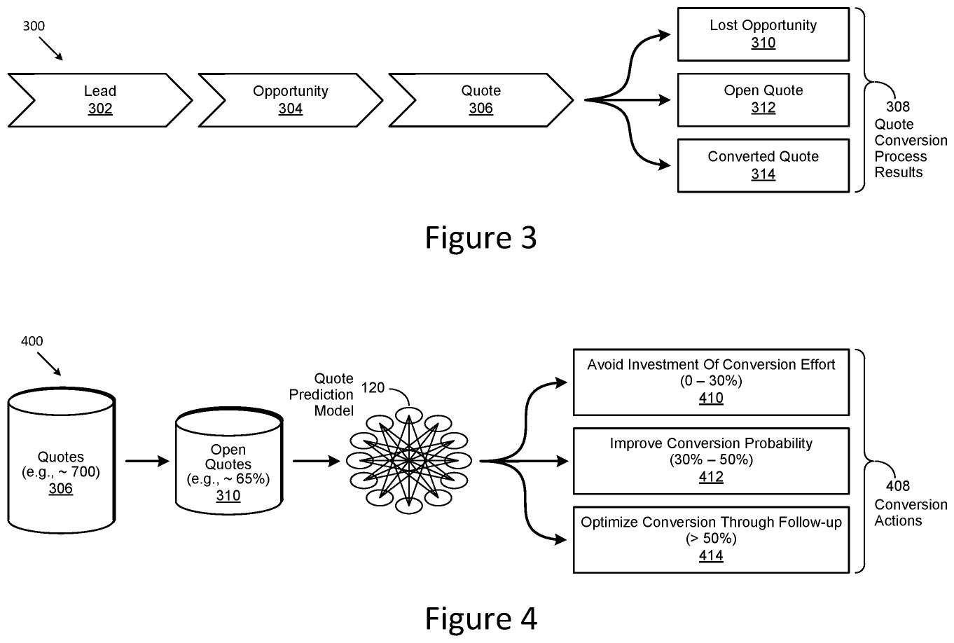

FIG. 3 shows a functional block diagram of a quote conversion process implemented in accordance with an embodiment of the invention. In certain embodiments, the quote conversion process 300 may include the receipt of a lead 302, which may then be qualified into an opportunity 304, which in turn may be developed into a quote 306. As used herein, a lead 302 broadly refers to information corresponding to a set of desires, needs or requirements of an entity that may culminate in the provision of a deliverable, such as information, a service, or a product. For example, a prospective customer may have expressed a need for a color printer that costs less than $100.00, including shipping, and can be delivered in five days or less.

As likewise used herein, an opportunity 304 broadly refers to a lead that can be fulfilled. In certain embodiments, an opportunity may include a request for a quote (RFQ). To continue the prior example, a vendor of printers may have three color printers for sale, a first inkjet model for $89.95 and a second inkjet model for $109.95, either of which can be discounted for $20.00, and a color laser model for $129.95, which cannot be discounted. Furthermore, the price for each of the three printers may include free shipping. In this example, the opportunity 304 is for the vendor to propose the provision of one of the two inkjet models, with respectively-discounted prices of $69.95 and $89.95, as the undiscounted price for the color laser model is more than the $100.00 budgetary limit imposed by the prospective customer.

A quote 306, as likewise used herein, broadly refers to proposed pricing, terms and conditions associated with the provision of a deliverable. To further continue the prior example, the prospective customer may request a quote 306 for the two inkjet models as they may need management approval to complete a purchase. In this example, the quote may include the discounted price for each of the two inkjet printers (e.g., respectively $69.95 and $89.95, each reflecting the $20.00 discount), terms (e.g., shipping included, 90 day warranty), and conditions (e.g., payment by payment card, estimated delivery 3 to 5 days by ground shipping). As likewise used herein, quote conversion broadly refers to an agreement to accept the proposed pricing, terms and conditions of an associated quote for the provision of a deliverable. To continue the prior example, the prospective customer's agreement to accept the quote 306 for one of the two inkjet printers results in a conversion of the quote 306 into a sale.

In various embodiments, the result 308 of the quote conversion process 300 may be a lost opportunity 310, a quote remaining open 132, or a converted quote 314. As used herein, a lost opportunity 310 broadly refers to a quote 306 that was not accepted. An open quote 312, as likewise used herein, broadly refers to a quote 306 that has not yet been accepted, but may at some point in time. As likewise used herein, a converted quote 314 broadly refers to a quote 306 whose proposed pricing, terms and conditions has been accepted for provision of an associated deliverable. Certain embodiments of the invention reflect an appreciation that an open quote 312 may eventually result in a lost opportunity 310 or a converted quote 314.

FIG. 4 shows a functional block diagram of a quote prediction model implemented in accordance with an embodiment of the invention to optimize a quote conversion process. In certain embodiments, a certain number (e.g., 700+/−10%) of quotes 306 may be generated, of which a certain percentage (e.g., 65%+/−10%) may be open quotes 310. In certain embodiments, a quote prediction model 120, described in greater detail herein, may be implemented to optimize the quote conversion process by determining an associated conversion action 408 for various classifications of open quotes 306. In certain embodiments, the quote prediction model 120 may be implemented as a logistic model, likewise described in greater detail herein.

In certain embodiments, one such conversion action 408 may be to avoid investment of quote conversion efforts 408 for a particular percentage (e.g., 30%+/−10%) of the open quotes 310. As an example, an opportunity associated with a particular open quote 310 may not be fully qualified. Examples of such qualification may include articulation of a quantifiable or qualifiable need, a deadline for acceptance or rejection of the open quote 310, an identified decision maker, or a committed budget, if applicable. Skilled practitioners of the art will recognize that many such qualifications are possible. Accordingly, the foregoing is not intended to limit the spirit, scope or intent of the invention.

In various embodiments, another conversion action 408 may be to improve quote conversion probability 412 for a certain percentage (e.g., 30%-50%) of the open quotes 310. For example, an open quote 310 may include alternative deliverables, such as a product with additional functionalities or capabilities for a modest increase in cost. In certain embodiments, yet another conversion action 408 may be to optimize quote conversion through follow-up 414 for a particular percentage (e.g., >50%) of the open quotes 310. As an example, a sales representative may be tasked with contacting a prospective customer to determine whether an open quote 310 can be converted in exchange for various incentives. In these embodiments, the percentage of open quotes 310 allocated to each conversion action 408 is a matter of design choice. Those of skill in the art will likewise recognize that many such conversion actions 408 are possible. Accordingly, the foregoing is not intended to limit the spirit, scope or intent of the invention.

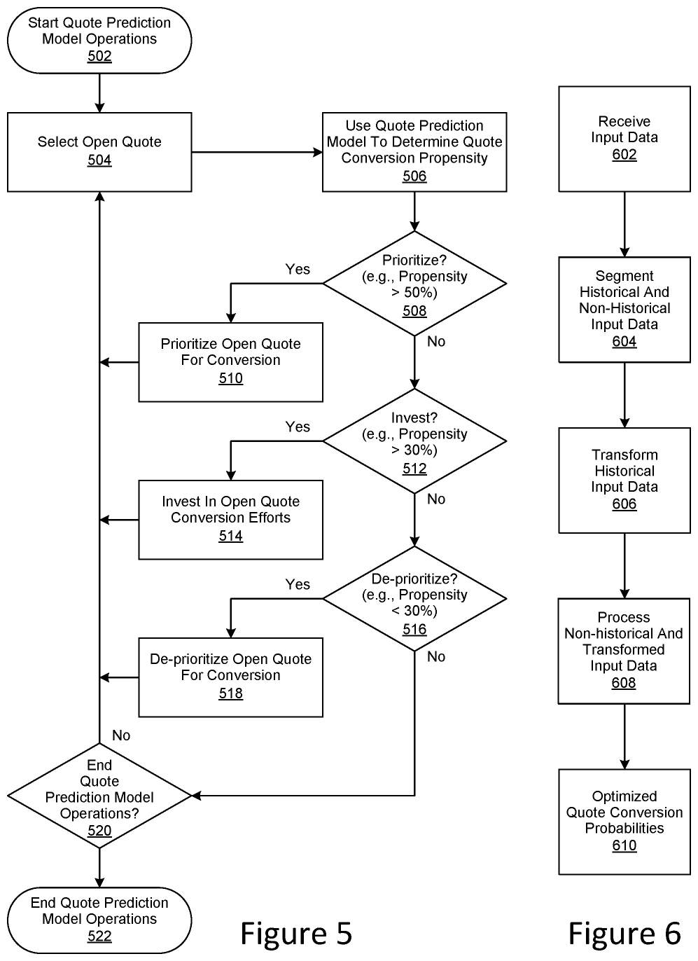

FIG. 5 shows a flow chart of quote the performance of prediction model operations implemented in accordance with an embodiment of the invention. In this embodiment, quote prediction model operations are begun in step 502, followed by the selection of an open quote in step 504. A quote prediction model, described in greater detail herein, is then used in step 506 to determine the propensity of the open quote selected in step 504 to be converted.

A determination is then made in step 508 to determine whether the propensity (e.g., >50%) of the open quote to be converted justifies its prioritization. If so, then the open quote is prioritized in step 510 for associated quote conversion efforts, described in greater detail herein. Otherwise, a determination is made in step 512 to determine whether the propensity (e.g., >30%) of the open quote to be converted justifies investment in various quote conversion efforts. If so, then investments are made in step 514 for associated conversion efforts, likewise described in greater detail herein. Otherwise, a determination is made in step 508 to determine whether the propensity (e.g., <30%) of the open quote to be converted justifies its de-prioritization. If so, then the open quote is de-prioritized in step 518.

Otherwise, a determination is made in step 520 whether to end quote prediction model operations. If not, or after the open quote has been respectively prioritized, invested in, or de-prioritized in steps 510, 514 and 518, the process is continued, proceeding with step 504. Otherwise quote prediction model operations are ended in step 522.

FIG. 6 shows a functional block diagram of the operation of a quote prediction model implemented in accordance with an embodiment of the invention. In this embodiment, various input data 602, described in greater detail herein, is received and then segmented 604 into historical and non-historical input data. In certain embodiments, the historical and non-historical input data may be segmented 604 into various classes. In these embodiments, the classes used to segment 604 the non-historical input data is a matter of design choice. The historical input data is then transformed 606 and processed 608 with the non-historical input data, as likewise described in greater detail herein, to generate optimized quote conversion probabilities 610.

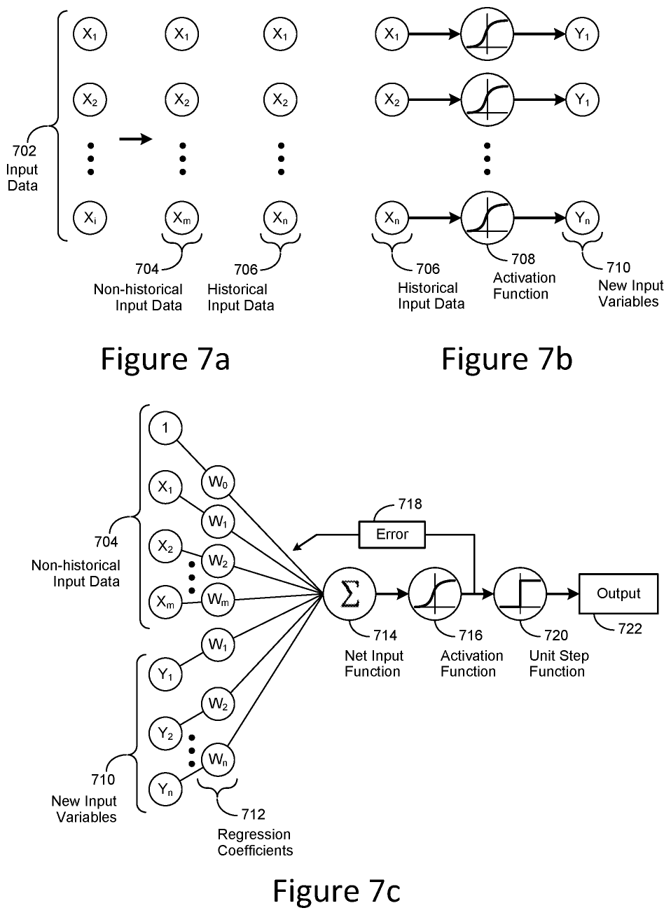

FIGS. 7a through 7c show a logistic model implemented in accordance with an embodiment of the invention as a quote prediction model. In certain embodiments the logistic model is implemented to perform logistic regression analysis operations associated with optimizing the conversion of quotes. As used herein, a logistic model, also known as a logit model, broadly refers to a statistical model that uses a logistic function to describe the relationship between a qualitative dependent variable and an independent predictor variable. As likewise used herein, a logistic function broadly refers to the inverse of the natural logit function. Accordingly, it can be used to convert the logarithm of odds into a probability.

A qualitative dependent variable, as used herein, refers to a variable that can take only certain discrete values, which are dependent upon that of others. Likewise, as used herein, an independent predictor variable broadly refers to a variable whose value determines that of others. Logistic regression analysis, as likewise used herein, broadly refers to estimating the parameters of a logistic model. In certain embodiments, known logistic regression approaches may be implemented to measure the relationship between a categorical dependent variable and one or more independent variables by estimating probabilities using a logistic function.

More formally, a logistic model is one where the log-odds of the probability of an event is a linear combination of independent or predictor variables. As typically implemented, the two possible dependent variable values are often labeled as ‘0’ and ‘1’, which represent outcomes such as pass/fail, win/lose, and so forth. In certain embodiments, the qualitative dependent variable relates to quote conversion (Yes No). In certain embodiments, the objective of the invention is to predict whether or not a quote will be converted, which can be treated as a binomial classification where conversion=1 and non-conversion=0, which can be represented in a binary logistic regression notation as:

Log(Y−1/Y)=β₀X₀+β₁X₁+β₂X₂β₃X₃+ . . . +βᵥXᵥ

where ‘Y’ is the dependent variable representing quote conversion and Log is used to denote a binary classification of ‘0’ or ‘1’. In certain embodiments, the binary classification may be implemented to indicate whether a quote will be converted or not. In certain embodiments, a binary classification of ‘0’ denotes the quote is either open or failed to convert. Likewise, a binary classification of ‘1’ denotes that the quote has been converted.

Likewise, ‘X₁’ through ‘X_{y}’ denote various independent variables a quote conversion is dependent upon, as described in greater detail herein. As likewise used herein, ‘β’ represents the coefficients associated with the independent variables. As such, it provides a measure of the magnitude of the association between a particular independent variable and the dependent variable. As an example, a positive coefficient indicates a particular independent variable is directly proportional to the dependent variable. In various implementations, the binary logistic regression model can be generalized to more than two levels of the dependent variable. For example, categorical outputs with more than two values may be modeled by multinomial logistic regression, and if the multiple categories are ordered, by ordinal logistic regression, such as in a proportional odds ordinal logistic model.

Referring now to FIG. 7a, a set of input data x₁, x₂ through xᵢ 702 is segmented to create a set of non-historical input data x₁, x₂ through xₙ 704 and a set of historical input data x₁, x₂ through xₙ 706. In certain embodiments, the set of non-historical data may include information related to the requestor of the quote, the requested deliverable, the purchase power of the requestor, and the market segment associated with the quote requestor. In certain embodiments, the information related to the requested deliverable may include quantities, pricing, discounts, delivery methods, payment terms, and so forth. In certain embodiments, the set of historical data may include information related to the quote requestor's quote conversion history, the quote provider's overall quote conversion history, their conversion history for the requested deliverable, and their conversion history for the requestor's associated market segment.

As shown in FIG. 7b, the resulting set of historical input data x₁, x₂ through xₙ 706 is then processed with an activation function 708 to generate a set of new input variables y₁, y₂ through yₙ 710. In certain embodiments, the activation function 708 may be implemented to reflect the ratio of all converted quotes to all quotes provided to quote requestors in the past to achieve a desired result, such as a conversion ratio. In certain embodiments, the new input variables 710 will be the results generated from the historic input variables 706. In certain embodiments the new input variables 710 may include historic quote conversions associated with a particular quote provider. In certain embodiments, the historic quote conversions may be likewise be associated with a particular market segment.

The resulting set of new input variables y₁, y₂ through yₙ 710 are then processed with the set of non-historical input data x₁, x₂ through xₙ 704 to respectively generate a set of regression coefficients w₁, w₂ through wₘ and w₁, w₂ through wₙ 712. In certain embodiments, the regression coefficients w₁, w₂ through wₘ and w₁, w₂ through wₙ 712 may be used in combination with one another. In certain embodiments, the resulting set of new input variables y₁, y₂ through yₙ 710 enhance the accuracy of the model and are used in addition to the standard variables (e.g., the set of non-historical input data x₁, x₂ through xₙ 704) typically used by a logistic regression function. In certain embodiments, the regression coefficients w₁, w₂ through wₘ and w₁, w₂ through wₙ 712 may be implemented to represent the change in the logistic model for each unit change in a corresponding independent or predictor variable.

Referring to FIG. 7c, the set of regression coefficients w₁, w₂ through wₘ and w₁, w₂ through wₙ 712 are then processed with a net input function 714, the results of which are then processed by an activation function 716. In certain embodiments, the net input function may be implemented as a collection of raw data provided to the logistic regression model along with new input variables y₁, y₂ through yₙ 710. In certain embodiments, errors 718 associated with the results of the activation function 716, such as insignificant variables, are removed from the non-historical input data 704 and the new input variables 710 and the process is repeated. Likewise, the results of the activation function 716 are processed by a unit step function 720 to generate an output 722. In certain embodiments, the unit step function is implemented to process the continuous output from the activation function 716 to generate a finery output, where ‘1’=conversion and ‘0’=non-conversion via a particular threshold value. In these embodiments, the selection of a particular threshold value is a matter of design choice. In certain embodiments, the output 722 may be implemented to provide a propensity of an open quote to be converted, as described in greater detail herein.

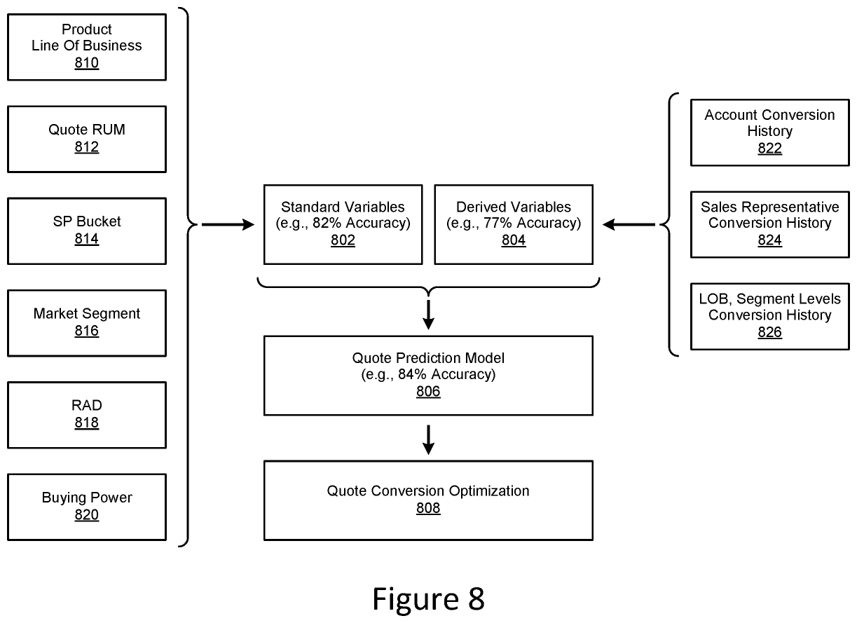

FIG. 8 shows a simplified block diagram of variables associated with a quote prediction model implemented in accordance with an embodiment of the invention. In certain embodiments, the use of standard variables 802, such as the non-historical input data 704 described in the text associated with FIG. 7, may provide a first prediction of the propensity for a quote to be converted. In certain embodiments, the standard variables 802 may include a product or line of business (LOB) 810, various quote details 812, a discount bracket 814, a market segment 816, a relationship metric, buying power 820, or combination thereof.

Likewise, the use of derived values 804, such as the new input variables 710 described in the text associated with FIG. 7, may provide a second prediction of the propensity for a quote to be converted. In certain embodiments, the derived variables 804 may likewise be oriented to historical input data 706, described in the text associated with FIG. 7. In certain embodiments, the derived variables 804 may include historical account 822, quote provider 824, and LOB or market segment 826 conversion history.

In certain embodiments, the use of standard variables 802 may provide a higher accuracy (e.g., ˜82%) of predicted propensity for a quote to be converted than the accuracy (e.g., ˜77%) provided by the use of derived variables 804 when the two sets of variables are used alone. However, as described in greater detail herein, the implementation of a quote prediction model 806 typically results in a higher accuracy (e.g., ˜84%) when the two sets of variables are used in combination. Accordingly, quote conversion optimization 808 may be realized in certain embodiments.

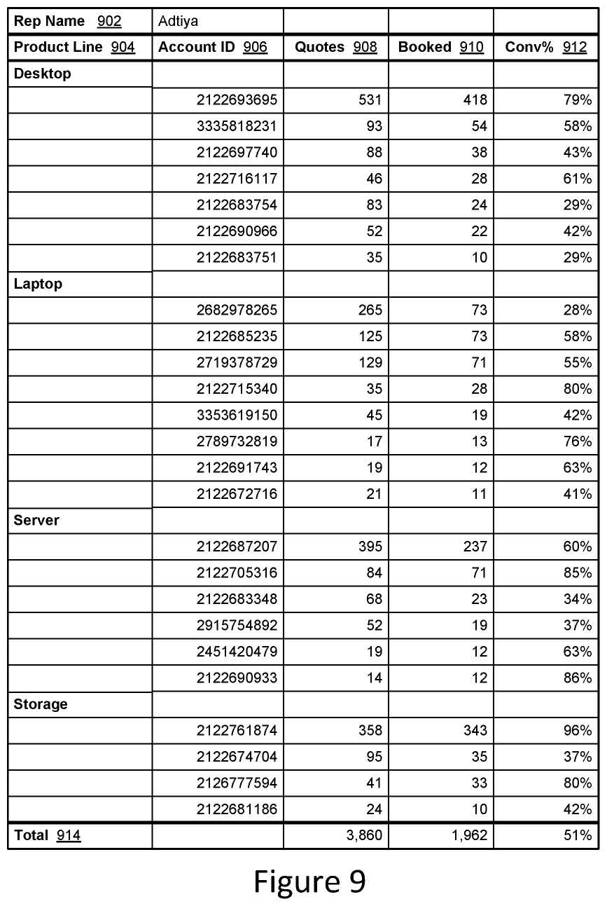

FIG. 9 is a table of quote variables and associated input data implemented in accordance with an embodiment of the invention. In certain embodiments, the quote variables and associated data shown in FIG. 9 may be used as non-historical 704 and historical 706 input data to a quote prediction model, as described in the descriptive text associated with FIG. 7. In this embodiment, quote variables may include the name 902 of a sales representative responsible for managing a quote, a product line 904, and an account identifier (ID) 906. As likewise shown in FIG. 9, associated input data may include the current number of open quotes 908, the number of booked, or converted, quotes 910, corresponding conversion percentages 912, and associated totals 914.

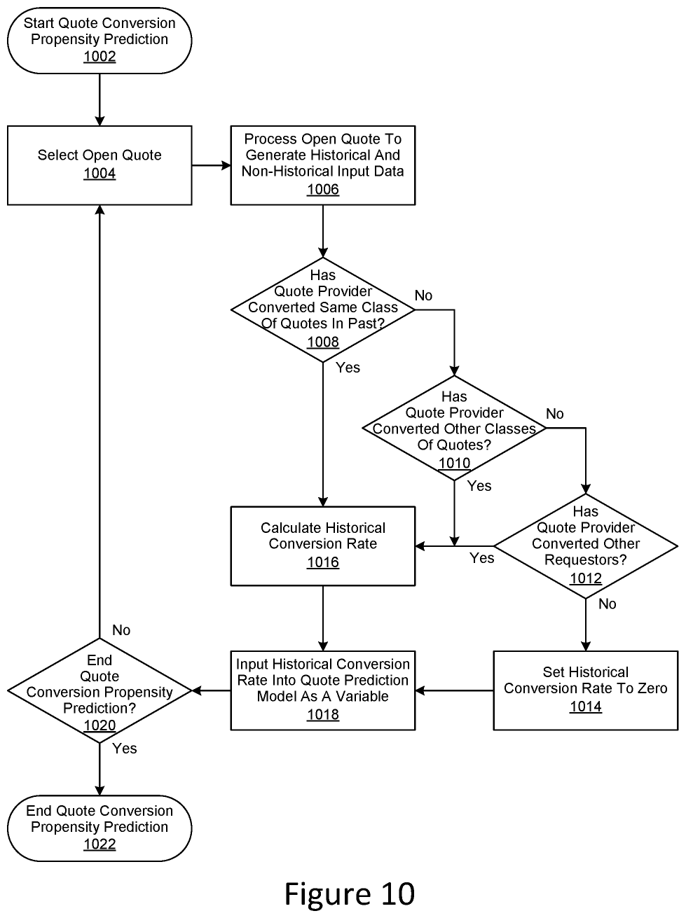

FIG. 10 shows a flowchart of the performance of quote conversion propensity prediction operations implemented in accordance with an embodiment of the invention. In this embodiment, quote conversion propensity prediction operations are begun in step 1002, followed by the selection of an open quote in step 1004. Information related to the open quote is then processed in step 1006 to generate historical and non-historical input data, described in greater detail herein. In certain embodiments, the historical input data may include the identity of the quote requestor, the identity of the quote provider, and their respective quote conversion history, including classes of quotes converted and their related market segments.

A determination is then made in step 1008 whether the quote provider has converted the same class of quotes as the open quote for the quote requestor in the past. As an example, a sales representative may have successfully converted multiple quotes for laptop computers into sales to an existing customer. If it was determined in step 1008 that the quote provider has not converted the same class of quotes as the open quote for the quote requestor in the past, then a determination is made in step 1010 whether the quote provider has converted a different class of quotes as the open quote for the quote requestor in the past. As an example, the open quote may be for servers, which the sales representative may not have sold to the quote requestor in the past, despite having successfully converted multiple quotes to the same quote requestor for laptop computers.

If it was determined in step 1010 that the quote provider has not converted a different class of quotes as the open quote for the quote requestor in the past, then a determination is made in step 1012 whether the quote provider has converted open quotes for other quote requestors in the same market segment as the quote requestor. For example, the quote provider may not have previously converted an open quote for the quote requestor of the open quote selected in step 1004, but they may have successfully converted quotes for other quote requestors in the same market segment. If in was determined in step 1012 that the quote provider has not converted quotes for other quote requestors in the same market segment, then their associated conversion rate for the open quote is set to zero 0 in step 1014.

However, if it was respectively determined in step 1008, 1010 or 1012 that the quote provider has successfully converted open quotes, then a historical conversion rate for the open quote is calculated in step 1016. Thereafter, or if the historical conversion rate has been set to zero in step 1014, the resulting historical conversion rate is provided as input to a quote prediction model in step 1018, as described in greater detail herein. A determination is then made in step 1020 whether to end quote conversion propensity prediction operations. If not, then the process is continued, proceeding with step 1004. Otherwise, quote conversion propensity prediction operations are ended in step 1022.

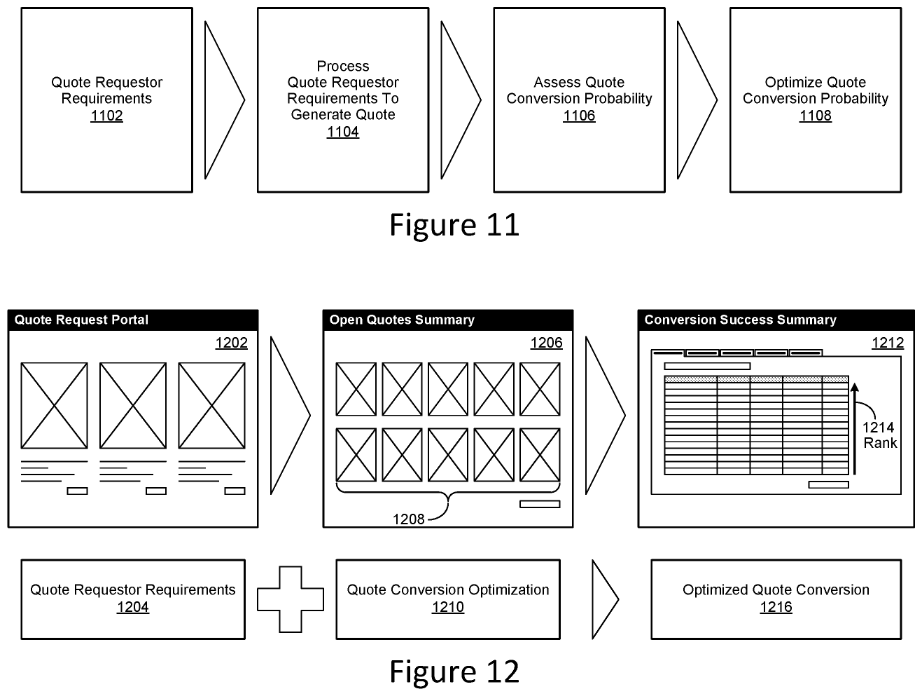

FIG. 11 shows a functional block diagram of the operation of a quote conversion optimization system implemented in accordance with an embodiment of the invention. In certain embodiments, quote requestor requirements, such as details associated with provision of a particular deliverable, are received in step 1102. In these embodiments, the method by which the quote requestor requirements are received is a matter of design choice. As an example, the quote requestor may enter their requirements into a customer portal. As another example, the quote requestor may provide their requirements in the form of a Request For Proposal (RFP) or Request For Quote (RFQ).

In certain embodiments, the quote requestor's requirements are then processed in step 1104 to generate a quote. In these embodiments, the method by which the quote is generated is a matter of design choice. For example, in certain embodiments the generation of the quote may be automated or semi-automated. Likewise, the quote may be manually generated in certain embodiments. In certain embodiments, the quote may be posted to a customer portal for review by the quote requestor, the quote provider, and others. In certain embodiments, the conversion probability of the resulting quote may then be assessed in step 1106, as described in greater detail herein. Once its conversion probability has been assessed, the probability of converting the quote may be optimized in step 1108.

FIG. 12 shows an example screen presentation of a quote conversion optimization system user interface implemented in accordance with an embodiment of the invention. In this embodiment, quote requestor requirements 1204 are entered into a user interface (UI) of a quote request portal 1202. In turn, the quote requestor requirements 1204 are processed to generate open quotes. In certain embodiments, the resulting open quotes may be displayed within the UI of an open quotes summary 1206 system. In certain embodiments, the open quotes may be categorized into various classes 1208. In these embodiments, the method by which the open quotes are classified is a matter of design choice.

In certain embodiments, various quote conversion optimization 1210 operations, described in greater detail herein, are then performed on the open quotes to optimize their conversion 1216. In certain embodiments, the resulting optimized open quotes are displayed within a UI of a conversions success summary 1212 system. In certain embodiments, the optimized open quotes may be displayed in a ranked 1214 order within the optimized open quotes are displayed within the UI of a conversions success summary 1212 system.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for optimizing quote conversion rates, comprising:
identifying an open quote associated with a particular potential acquirer of a deliverable;
identifying input data related to the open quote;
generating a prediction of a propensity of a particular open quote to be converted using the input data; and
using the prediction of the propensity of the particular open quote to optimize conversion of the open quote.

2. The method of claim 1, wherein:
the input data comprises historical input data and non-historical input data.

3. The method of claim 2, wherein:
the historical input data comprises at least one of historical information associated with a quote requestor, a particular quote request, a quote provider, and previously-converted quotes.

4. The method of claim 2, wherein:
the non-historical input data comprises at least one of information related to a quote requestor, a requested deliverable, a purchase power of the quote requestor and the market segment associated with the quote requestor.

5. The method of claim 1, further comprising:
identifying an open quote with a higher propensity for conversion from a plurality of open quotes, the identifying allowing a quote provider to facilitate conversion of open quotes.

6. The method of claim 1, wherein:
the generating the prediction further comprises applying a logistic model to the input data.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
identifying an open quote associated with a particular potential acquirer of a deliverable;
identifying input data related to the open quote;
generating a prediction of a propensity of a particular open quote to be converted using the input data; and
using the prediction of the propensity of the particular open quote to optimize conversion of the open quote.

8. The system of claim 7, wherein:
the input data comprises historical input data and non-historical input data.

9. The system of claim 8, wherein:
the historical input data comprises at least one of historical information associated with a quote requestor, a particular quote request, a quote provider, and previously-converted quotes.

10. The system of claim 8, wherein:
the non-historical input data comprises at least one of information related to a quote requestor, a requested deliverable, a purchase power of the quote requestor and the market segment associated with the quote requestor.

11. The system of claim 7, wherein the instructions executable by the processor are further configured for:
identifying an open quote with a higher propensity for conversion from a plurality of open quotes, the identifying allowing a quote provider to facilitate conversion of open quotes.

12. The system of claim 7, wherein:
the generating the prediction further comprises applying a logistic model to the input data.

13. A non-transitory, computer-readable storage medium embodying computer program code, the computer program code comprising computer executable instructions configured for:
identifying an open quote associated with a particular potential acquirer of a deliverable;
identifying input data related to the open quote;
generating a prediction of a propensity of a particular open quote to be converted using the input data; and
using the prediction of the propensity of the particular open quote to optimize conversion of the open quote.

14. The non-transitory, computer-readable storage medium of claim 13, wherein:
the input data comprises historical input data and non-historical input data.

15. The non-transitory, computer-readable storage medium of claim 14, wherein:
the historical input data comprises at least one of historical information associated with a quote requestor, a particular quote request, a quote provider, and previously-converted quotes.

16. The non-transitory, computer-readable storage medium of claim 14, wherein:
the non-historical input data comprises at least one of information related to a quote requestor, a requested deliverable, a purchase power of the quote requestor and the market segment associated with the quote requestor.

17. The non-transitory, computer-readable storage medium of claim 13, wherein the computer executable instructions are further configured for:
identifying an open quote with a higher propensity for conversion from a plurality of open quotes, the identifying allowing a quote provider to facilitate conversion of open quotes.

18. The non-transitory, computer-readable storage medium of claim 13, wherein:
the generating the prediction further comprises applying a logistic model to the input data.

19. The non-transitory, computer-readable storage medium of claim 13, wherein:
the computer executable instructions are deployable to a client system from a server system at a remote location.

20. The non-transitory, computer-readable storage medium of claim 13, wherein:
the computer executable instructions are provided by a service provider to a user on an on-demand basis.
